(19) United States
(12) Patent Application Publication
(10) Pub. No.: US 2026/0265145 A1
(43) Pub. Date: Sep. 10, 2026

(54) PUMPABLE HYBRID CEMENTITIOUS MATERIAL

(71) Applicant: Arizona Board of Regents on Behalf of the University of Arizona, Tucson, AZ (US)

(72) Inventors: Lianyang Zhang, Tucson, AZ (US); Arash Nikvar Hassani, Tucson, AZ (US)

(21) Appl. No.: 19/167,813

(22) PCT Filed: Apr. 15, 2024
(86) PCT No.: PCT/US2024/024680

§ 371 Date: Sep. 22, 2025

Related U.S. Application Data
(60) Provisional application No. 63/459,254, filed on Apr. 13, 2023.

(51) Int. Cl. C04B 28/26; C04B 18/08; C04B 18/162; C04B 22/06; C04B 24/38; C04B 40/06; C04B 103/32; C04B 111/00; E21D 15/00

(52) U.S. Cl. CPC C04B 28/26; C04B 18/08; C04B 18/162; C04B 22/062; C04B 24/38; C04B 40/065; C04B 2103/32; C04B 2111/00146; E21D 15/005

(57) ABSTRACT

A hybrid cementitious material is disclosed which can be used for roof support in underground mines, and includes a first mixture and a second mixture. The first mixture can include a precursor, a superplasticizer and water, the precursor including fly ash, cement kiln dust, and/or ordinary Portland cement; the second mixture can include water, sodium hydroxide, sodium silicate and a biopolymer. The first mixture and second mixture can have sufficiently low viscosity to be pumpable over long distances such that upon arrival at a desired location, the first and second mixtures can be combined to form the cementitious material. The cementitious material when cured combines advantageous properties including: high peak and residual compressive strength, and good stability when exposed to air. Example methods are also provided for preparing the hybrid cementitious material.

### CROSS REFERENCE TO RELATED APPLICATIONS

This is a PCT application that claims benefit to U.S. provisional application Ser. No. 63/459,254 filed on Apr. 13, 2023 which is incorporated by reference in its entirety.

### FIELD

The present disclosure generally relates to mining systems and compositions including cementitious materials; in particular to a pumpable hybrid cementitious material.

### BACKGROUND

Ground falls are one of the main hazards in underground mining projects. It has been reported that ground falls lead to 8 to 10 fatalities and more than 800 injuries every year, counting approximately 30% of the fatal accidents and 15% of the injuries that happen in underground mines. Therefore, design and construction of appropriate roof supports to prevent ground falls and ground fall accidents are of paramount importance.

Currently, there are two main types of roof support systems: the intrinsic support systems like roof bolts, and the standing support systems such as cribs, posts, and longwall shields. FIGS. 1A and 1B shows examples of conventional standing supports. Both support systems have limitations.

Among the standing roof support systems, Can supports are likely the most widely used roof support system in the United States for longwall tailgate applications. This support system provides large deformation support and consistent loading as much as 50% strain which improves ground support. However, the Can support is usually topped off with timbers to establish roof contact, which softens the support response due to the contact compatibility of the timbers with the uneven roof. In this regard, wedges are used to provide a tight fit to increase the resistance against roof convergence.

It is with these observations in mind, among others, that various aspects of the present disclosure were conceived and developed.

### SUMMARY

The present disclosure provides a number of examples that describe cementitious material compositions and techniques for making the same. In the context of the disclosed methods, devices, techniques, apparatus, systems, and so on, the terms “operable to,” “configured to,” and “capable of” used herein are interchangeable.

In a first set of illustrative examples, the inventive concept includes a cementitious material composition for pumpable roof supports in underground mining, wherein the cementitious material composition comprises a mixture comprising a first grout stream and a second grout stream, both the first and second grout streams being pumpable. The first grout stream can comprise a precursor including one or more geopolymer source materials (e.g. fly ash, cement kiln dust, ordinary Portland cement, lime) and water; and the second grout stream can comprise a biopolymer, sodium silicate or potassium silicate, water, and a hydroxide chosen from potassium hydroxide, calcium hydroxide, and sodium hydroxide. In one example, the precursor of said first grout stream can include cement kiln dust, ordinary Portland cement, or lime, and in yet another example, the first grout stream further comprises a superplasticizer/

In another aspect the present inventive concept includes a method of preparing a cementitious material, said method comprising separately pumping a first grout stream comprising a precursor and water and a second grout stream comprising a silicate, a hydroxide, a biopolymer, and water to a mixing location, forming, at the mixing location, a combination of the first grout stream and the second grout stream, and mixing, at the second location, the combination of the first grout stream and the second grout stream to form the cementitious composition. In some examples, the precursor can include a pozzolanic material and ordinary Portland cement. The mixing location, in one example, may be in an underground mine.

In some examples, the method includes pumping the cementitious mixture from the mixing location to a container (e.g., a crib bag), and allowing time for the cementitious composition to cure.

The foregoing examples broadly outline various aspects, features, and technical advantages of examples according to the disclosure in order that the detailed description that follows may be better understood. It is further appreciated that the above features described in the context of the illustrative example method, compositions, and systems are not required and that one or more features may be excluded and/or other additional features discussed herein may be included. Additional features and advantages will be described hereinafter. The conception and specific examples illustrated and described herein may be readily utilized as a basis for modifying or designing other structures for carrying out the same purposes of the present disclosure. Such equivalent constructions do not depart from the spirit and scope of the appended claims.

### BRIEF DESCRIPTION OF THE DRAWINGS

FIGS. 1A-1B are images showing examples of conventional standing supports.

FIG. 2A is an image showing a crib bag installed in a collapsed configuration to the mine roof.

FIG. 2B is an image showing a crib bag after filling with cementitious material.

FIG. 3A is a box diagram depicting the first and second mixtures (grout streams) of the hybrid cementitious material composition.

FIG. 3B is a flow chart of two grout streams pumped to a crib bag to form pumpable roof support.

FIG. 4A is a chart showing setting time of GP cementitious material at 1 wt. % SP and 0 wt. % BP, and FIG. 4B is a chart showing setting time of GP cementitious material at 2 wt. % SP and 0 wt. % BP.

FIG. 5 is a chart showing viscosity of first stream with 20 wt. % CKD.

FIG. 6 is a chart showing seven-day UCS of GP cementitious material, with 0 wt. % BP and cured at 35° C.

FIG. 7 is a graph showing Stress-strain curves of hybrid geopolymer-biopolymer specimens at different BP contents (the BP was Gellan gum).

FIG. 8 is a chart showing the Young's modulus of the hybrid cementitious material specimens at different BP contents.

FIGS. 9A-9C are images of small size hybrid cementitious material cylinder specimens with 5 M NaOH, SS/SH=1, 20 wt. % CKD, 2 wt. % SP, 0.3 wt. % CAR, and cured at 35° C.: (a) with no bag; (b) with bag; and (c) with bag and plastic cable ties.

FIG. 10 is a graph showing stress-strain curves of small hybrid cementitious material cylinder specimens.

FIGS. 11A and 11B are images showing small size bagged hybrid cementitious material cylinder specimens tested for strength.

FIG. 12 is a graph showing comparison of stress-strain curves of the small size 0.3 wt. % CAR specimen with polyester bag and plastic cable ties in this project with those of full size crib bag specimens used in practice.

FIGS. 13A-13C are charts showing the effect of BP content on 7-day residual UCS of hybrid cementitious material at 5% strain with 20 wt. % CKD, W/S=0.55 and 0.60, 1 and 2 wt. % SP, and cured at 35° C.: FIG. 13A Carrageenan (CAR); FIG. 13B Gellan gum (GEL); and FIG. 13C Cellulose nanofibers (CNF).

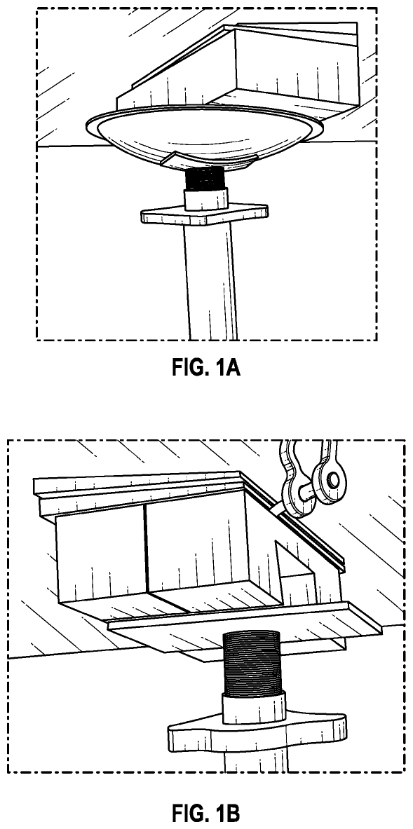

Corresponding reference characters indicate corresponding elements among the view of the drawings. The headings used in the figures do not limit the scope of the claims.

### DETAILED DESCRIPTION

Aspects of the present inventive disclosure relate to example hybrid cementitious materials for roof support in underground mines. In some examples, the hybrid material comprises a composition of a first mixture and a second mixture. The first mixture can include a precursor, water, and a superplasticizer, the precursor including fly ash, cement kiln dust, and ordinary Portland cement; and the second mixture can include water, sodium hydroxide, sodium silicate and a biopolymer. In some examples, the first mixture and the second mixture can be combined using a first grout stream for the first mixture and a second grout stream for the second mixture to form the hybrid cementitious material at a predetermined location. The cementitious material when cured combines advantageous properties including: high peak and residual compressive strength, and good stability when exposed to air.

### Definitions

For the purpose of promoting an understanding of the principles of this inventive concept, reference will now be made to certain examples and specific language will be used to describe the same. It will nevertheless be understood that no limitation of the scope of the inventive concept is thereby intended, and alterations and modifications in the illustrated inventive concept, and further applications of the principles of the inventive concept as illustrated therein are herein contemplated as would normally occur to one skilled in the art to which the inventive concept relates.

Unless defined otherwise, all technical and scientific terms used herein have the same meaning as commonly understood by one of ordinary skills in the art to which this inventive concept pertains.

For the purpose of interpreting this specification, the following definitions will apply and whenever appropriate, terms used in the singular will also include the plural and vice versa. In the event that any definition set forth below conflicts with the usage of that word in any other document, including any document incorporated herein by reference, the definition set forth below shall always control for purposes of interpreting this specification and its associated claims unless a contrary meaning is clearly intended (for example in the document where the term is originally used).

The use of “or” means “and/or” unless stated otherwise.

The use of “a” herein means “one or more” unless stated otherwise or where the use of “one or more” is clearly inappropriate.

The use of “comprise,” “comprises,” “comprising,” “include,” “includes,” and “including” are interchangeable and not intended to be limiting. Furthermore, where the description of one or more examples uses the term “comprising,” those skilled in the art would understand that, in some specific instances, the example or examples can be alternatively described using the language “consisting essentially of” and/or “consisting of.”

As used herein, the term “about” refers to a ±10% variation from the nominal value. It is to be understood that such a variation is always included in any given value provided herein, whether or not it is specifically referred to.

As used therein, the term “pumpable” refers to where the first and/or second grout stream has a viscosity below 300 cP. The term “pumpable” also refers to the possibility of transporting a slurry/grout within a pipe from the ground surface to the underground mine over a long distance (e.g., over 5000 ft. (~1500 meters)). The slurry or grout is pumpable for a long distance if it has a viscosity below 300 cP.

As used therein, the term “geopolymer” (abbreviated as “GP”) refers to an inorganic material formed via alkali activation of aluminosilicates at ambient or slightly elevated temperatures. Different raw materials that contain reactive or amorphous silica and alumina can be used for GP production, including fly ash, mine waste, and slag. GP has many advantages compared to the conventional Portland cement, including rapid strength gain, high strength, low shrinkage, high thermal resistance, excellent acid resistance, and significantly reduced energy usage and greenhouse gas emissions.

As used therein, the term “biopolymer” (abbreviated as “BP”) refers to a high molecular weight organic material (e.g., carrageenan (CAR), gellan gum (GEL), Xanthan gum, Guar gum, Agar, cellulose nanocrystals (CNC), cellulose nanofibers (CNF)), etc.

As used herein, the term “grout stream” refers to a cementitious grout material and is used interchangeably with the term “stream” (e.g., first stream or second stream) to refer to one of the two fluids used to make pumpable roof supports.

### Introduction (& Technical Problems)

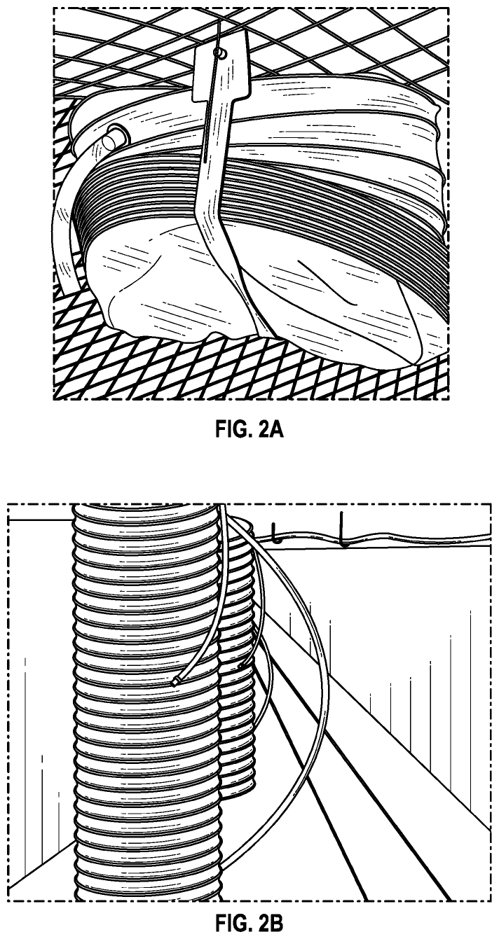

Pumpable roof supports have been increasingly used in mines to support the roof due to their advantages over other bulky standing roof support systems. As the name implies, a pumpable roof support is installed in place where roof support is required using a pumpable material, usually a cementitious grout. Typically, a two-component material is pumped from a remote location, generally, but not always, above ground, into a containment bag (crib bag) to form the support. The unfilled support bags are transported into the mine in a collapsed configuration, minimizing the transportation needs to the installation site. As shown in FIG. 2A, during installation the support bags are secured to the mine roof and then extended down to the floor. FIG. 2B shows a full support column forming as a two-component cementitious material is pumped into the containment bag. The solidified grout material captured by the containment bag provides a full support column between the mine roof and floor and thus eliminates the need for secondary materials such as wooden wedges to be installed to establish proper roof contact. Pumpable roof supports minimize the underground material handling efforts, thereby reducing the risk of injuries historically associated with in-mine support construction. On-site fabrication also facilitates application of the pumpable roof support in areas that are inaccessible to transportation equipment such as scoops or rail cars, making it ideal for many bleeder applications.

Pumpable roof supports have evolved during the past decade, including improvements on both containment bags and the cementitious material. Currently, calcium-sulfo-aluminate (CSA) cement and Portland cement (OPC) are the two main types of cementitious materials used for constructing pumpable roof supports. CSA generally has a faster setting time and strength gain due to ettringite formation; however, it is very expensive. It is also observed that OPC based cementitious material decomposes when exposed to air and loses its strength. Research has been conducted on the cementitious material aiming to enhance the performance of pumpable roof supports. For example, a previous study developed a cementitious grout mixture consisting of two pumpable grout streams, one composed of ordinary Portland cement and water and the other containing pulverized fuel ash (PFA) (as the pozzolan material), an inorganic gelling agent and water. The two pumpable grout streams are transported separately and simultaneously along separate pipelines to a point of application wherein the separate grout streams are combined into a grout mixture.

For a pumpable roof support to provide effective and safe support to the roof, it should have high load stiffness, high peak strength and large residual strength. However, the conventional cementitious grout materials currently used in practice cannot achieve these normally conflicting properties. To prevent ground falls and ground fall accidents, it is critical to enhance the cementitious material properties used in pumpable roof supports. In this regard, it is necessary to develop an unconventional cementitious material that possesses the normally conflicting properties of high load stiffness, high peak strength and large residual strength.

Geopolymer is a relatively new cementitious material which has been studied extensively during the last decades. Geopolymer is described as an inorganic material formed via alkali activation of aluminosilicates at ambient or slightly elevated temperatures which has an amorphous to semi-crystalline polymeric structure:

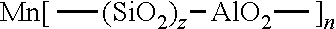

where M is an alkali cation (Na+ or K+), n is the degree of polymerization, and z is the number of SiO₂ monomer units per AlO₂. Different raw materials that contain reactive or amorphous silica and alumina can be used for geopolymer production, including fly ash, mine waste, and slag. Of particular note is that these raw materials are industrial wastes or byproducts, and therefore significant environmental and economic benefits are expected if the waste-based geopolymer is used in practice.

However, similar to conventional cementitious material, geopolymer also exhibits brittle behavior with low tensile strength, ductility and fracture toughness. There is a need for an improved cementitious material that addresses these drawbacks.

### Technical Solution (Geopolymer-Biopolymer Cementitious Material)

The present disclosure encompasses a novel high-performance hybrid pumpable cementitious material through effective fusion of geopolymer (GP) and biopolymer (BP). By incorporating a biopolymer, a high molecular weight organic material, in a geopolymer, an interpenetrating cross-linked network can be formed and serve as a binding and toughening agent in the geopolymer matrix, enhancing the performance of the composite cementitious material. This approach mimics the unique bio-formation process of natural superior performance biological materials such as nacre of abalone shells.

Because the main source material for the geopolymer is fly ash, a waste from coal power plants, the new cementitious material is more cost effective than the existing ones used in practice. Utilization of fly ash as the source material also reduces the monetary and environmental costs related to disposal and management of fly ash. Moreover, geopolymer can be produced at ambient or slightly elevated temperatures and thus consumes much less energy and releases much less greenhouse gasses than the conventional Portland cement. Furthermore, the presently disclosed hybrid geopolymer-biopolymer pumpable cementitious material possesses the normally conflicting properties of high load stiffness, high peak strength, and large residual strength for enhancing the performance of pumpable roof supports.

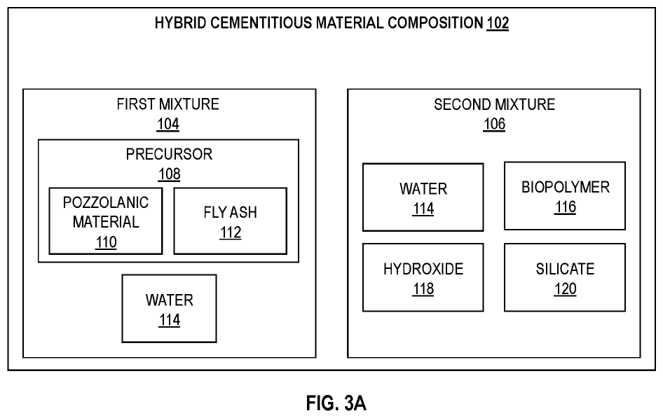

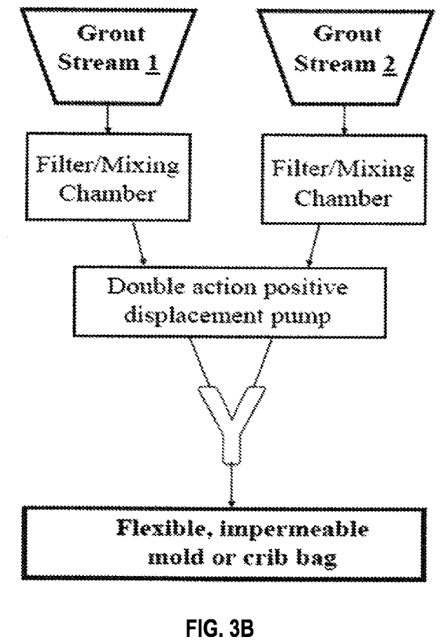

Referring to FIGS. 3A-3B, in one example of the present disclosure, a hybrid cementitious material composition 102 for pumpable roof supports in underground mining is formed from a first mixture (104) and a second mixture (106).

As depicted in FIG. 3B, the first mixture 104 can include a precursor 108 and water 114. The precursor 108 can include a pozzolanic material 110 and ordinary Portland cement 112. In one particular example, the precursor 108 of the first mixture is fly ash and cement kiln dust. The fly ash can be included in the first mixture 104 such that it acts as a source of aluminosilicate. In another example, the precursor 108 may include ordinary Portland cement 112 and/or lime. In yet another example, the first mixture can further include a superplasticizer.

In some examples, the second mixture 106 can include a silicate 120, a hydroxide 118, a biopolymer 116, and water 114. The biopolymer 116 can be selected from carrageenan, gellan gum, xanthan gum, guar gum, agar, cellulose nanocrystals, cellulose nanofibers, or a combination thereof. The silicate 120 of the second mixture 106 can be selected from sodium silicate, potassium silicate, or a combination thereof. Similarly, the hydroxide 118 can be selected from sodium hydroxide, potassium hydroxide, calcium hydroxide, or a combination thereof.

In some examples, the first and second mixtures are both pumpable, such that the mixtures can be pumped to a distant destination such as a location within a mine shaft. Said pumpable first and second mixtures can take the form of a first and second grout stream. In some examples, the first and second grout streams are combined or mixed after being pumped to a mixing location to form the hybrid cementitious material composition.

In some examples, the fly ash in said first mixture comprises metakaolin and/or slag.

In some examples, said first mixture comprises a superplasticizer in an amount from about 1 wt. % to about 4 wt. %, or even about 2 wt. %, relative to a sum of the weights of the precursor. In one such example, the precursor can include fly ash and cement kiln dust.

In some examples, a ratio of water to solids for the hybrid cementitious material composition comprising the first mixture and the second mixture is in a range from about 0.5 to about 0.7, from about 0.5 to about 0.65, or even about 0.6.

In some examples, the cement kiln dust in said first mixture is present in a range from about 10 wt. % to about 30 wt. %, or even about 20 wt. %, relative to the weight of the fly ash.

In some examples, the hybrid cementitious material composition comprising the first mixture and the second mixture exhibits an initial setting time in a range from about 20 min to about 40 min, and final setting time in a range from about 60 minutes to about 360 minutes.

In some examples, the biopolymer in the second mixture is chosen from carrageenan, gellan gum, cellulose nanofibers, xanthan gum, or agar.

In some examples, the biopolymer in the second mixture is chosen from carrageenan, gellan gum, or cellulose nanofibers.

In some examples, said biopolymer in said mixture is present in an amount in a range from about 0.1 wt. % to about 0.5 wt. %, or to even about 0.6 wt. %, relative to a total weight of the precursor. In one such example, the precursor includes fly ash and cement kiln dust.

In some examples, the carrageenan is present in an amount of about 0.3 wt. % relative to a total amount of solids in the mixture.

In some examples, the gellan gum is present in an amount of about 0.3 wt. % relative to a total amount of solids in the mixture.

In some examples, the cellulose nanofibers are present in an amount of about 0.5 wt. % relative to a total amount of solids in the mixture.

In some examples, the hybrid cementitious material composition comprises the sodium hydroxide in an amount in a range from about 3 mol to about 15 mol, or even about 5 mol.

In some examples, the hybrid cementitious material composition comprises a weight ratio of the sodium silicate to the sodium hydroxide in a range from about 0.1 to about 3, or even about 1.

In some examples, the viscosities of said first mixture and said second mixture are each not greater than about 300 cP, or even not greater than 200 cP.

In some examples, the viscosities of the first mixture and the second mixture are each no greater than about 300 cP for at least about 1 hour after preparation, or for even at least about 2 hours after preparation.

In some examples, a cured form of the mixture has a peak unconfined compressive strength greater than about 12.0 MPa.

In some examples, a cured form of the mixture has a residual unconfined compressive strength greater than about 3.0 MPa.

In some examples, a cured form of the mixture has a Young's modulus in a range from about 0.7 GPa to about 1.30 GPa.

Another aspect of the present inventive concept pertains to a cementitious material composition for pumpable roof supports in underground mining, wherein the cementitious material composition comprises a mixture comprising a first grout stream and a second grout stream, both the first and second grout streams being pumpable. The first grout stream can comprise a precursor including one or more geopolymer source materials (e.g. fly ash, cement kiln dust, ordinary Portland cement, lime) and water; and the second grout stream can comprise a biopolymer, sodium silicate or potassium silicate, water, and a hydroxide chosen from potassium hydroxide, calcium hydroxide, and sodium hydroxide. In one example, the precursor of said first grout stream can include cement kiln dust, ordinary Portland cement, or lime, and in yet another example, the first grout stream further comprises a superplasticizer.

Yet another aspect of the present inventive concept pertains to method of preparing a cementitious material, said method comprising separately pumping a first grout stream comprising a precursor and water and a second grout stream comprising a silicate, a hydroxide, a biopolymer, and water to a mixing location, forming, at the mixing location, a combination of the first grout stream and the second grout stream, and mixing, at the second location, the combination of the first grout stream and the second grout stream to form the cementitious composition. In some examples, the precursor can include a pozzolanic material and ordinary Portland cement. The mixing location, in one example, may be in an underground mine.

In some examples, the method includes pumping the cementitious mixture from the mixing location to a container (e.g., a crib bag), and allowing time for the cementitious composition to cure.

In some examples, said first grout stream is prepared by first mixing fly ash and cement kiln dust to obtain a homogeneous mixture, and then adding water and a superplasticizer and mixing further to obtain the first grout stream; and said second grout stream is prepared by first dissolving sodium hydroxide in a sodium silicate/water solution at least one day prior to use, and allowing the solution to cool to ambient temperature; and second, adding a biopolymer to the sodium hydroxide-sodium silicate-water solution and mixing well to obtain the second grout stream.

In some examples of said method, the first grout stream and the second grout stream are separately pumped from locations independently selected to be above ground level, at ground level, or even below ground level.

In another aspect of the present inventive concept, a method is provided for producing a cementitious support in an underground mine. The method can include separately pumping the first grout stream and the second grout stream from a first location to a second location, wherein the first location is above ground level and wherein the second location is within a mine located below ground level, forming, at the second location, a combination of the first grout stream and the second grout stream, mixing, at the second location, the combination of the first and second grout streams and pumping the mixture into a crib bag, and allowing the cementitious material to cure within the crib bag to provide a support to a surface of the mine.

In an example of said method, the surface of the mine is a roof.

In certain examples, the hybrid GP-BP cementitious material is a mixture of two separate pumpable grout streams, one composed of a precursor material and water, and optionally a superplasticizer, and the other containing sodium hydroxide, sodium silicate, biopolymer and water. The precursor material can include a pozzolanic material and ordinary Portland cement. A superplasticizer (SP) can also be used in the first stream to improve its workability. In some examples, the precursor comprises primarily fly ash (e.g., class F fly ash) and cement kiln dust as the source material.

### EXAMPLE APPLICATIONS

In one aspect, the present disclosure provides an innovative hybrid composite cementitious material through effective fusion of geopolymer and biopolymer. Without being bound by theory, it is considered that interpenetrating cross-linked network of biopolymer macromolecules may serve as a binding and toughening agent in the geopolymer matrix, leading to the observed improvement in mechanical properties. The hybrid geopolymer-biopolymer cementitious material not only inherits the many advantages of geopolymer itself, but also shows enhanced mechanical properties such as higher tensile strength, fracture toughness and ductility due to the incorporation of biopolymer.

In some examples, the new hybrid cementitious material is a mixture of two pumpable grout streams, a first grout stream comprising fly ash (for example, class F fly ash) and water, and a second grout stream comprising a hydroxide (e.g., NaOH, KOH, Ca(OH)₂), a silicate (e.g., sodium silicate, potassium silicate), a biopolymer and water. The fly ash in the precursor of the first grout stream provides aluminosilicate material for the geopolymer. The sodium hydroxide acts as the alkali activator required for geopolymer formation. The sodium silicate is used to adjust the Si/Al ratio and provide additional Na+ cations for charge balancing. The biopolymer is used to enhance the mechanical behavior of geopolymer through formation of an interpenetrating cross-linked network binding and toughening the geopolymer matrix. Cement kiln dust (CKD) and superplasticizer are also included in stream 1 for adjusting and controlling the setting time of the hybrid cementitious material and the pumpability of stream 1, respectively.

When the first grout stream and the second grout stream are separate (i.e., prior to mixing), they remain as a slurry and a solution, respectively, and can be easily handled and transported. When the two streams are mixed together and pumped into a crib bag, a hybrid geopolymer-biopolymer cementitious material is formed. FIG. 3B provides a representation of an example of the process. The new cementitious material can be tailored and used in practice at different conditions to achieve the optimum performance, for example, by adjusting the relative amount of the different components.

### Monitoring Setting Time

For field applications, after the two grout streams are poured into the crib bag, the mixture needs to gain strength quickly. Therefore, the setting time of the hybrid cementitious material is of great importance. In this regard, tests, such as VICAT tests, may be conducted to investigate the effect of water content represented by water to solid (W/S) ratio, CKD content, and superplasticizer (SP) amount on the setting time of the hybrid cementitious material.

In some examples, the geopolymer comprises primarily fly ash (e.g., class F fly ash) and cement kiln dust as the precursor source material. In other examples, the geopolymer comprises primarily fly ash and ordinary Portland cement as the precursor source material.

### EXAMPLES

### Application 1

### Materials and Methods

Abbreviations used for the materials are as follows:

| Abbreviation | Description |
|---|---|
| BP | Biopolymer (Gellan gum) |
| CKD | Cement kiln dust |
| FA | Class F fly ash |
| SH | Reagent grade (98%) sodium hydroxide |
| SP | Superplasticizer |
| SS | Sodium silicate |

The materials used for producing the hybrid cementitious material include class F fly ash (FA), cement kiln dust (CKD), reagent grade 98% sodium hydroxide (SH) (NaOH), sodium silicate (SS) (Na₂SiO₃) solution (SiO₂=29%, Na₂O=8%, and H₂O=63%), superplasticizer (SP), biopolymer (BP), and de-ionized water. Table 1 shows the chemical composition of FA and CKD from X-ray Fluorescence (XRF) analysis.

TABLE 1
Chemical composition of FA and CKD

| Chemical | | | | | | | | |
|---|---|---|---|---|---|---|---|---|
| compound | SiO₂ | Al₂O₃ | CaO | Fe₂O₃ | MgO | Na₂O | SO₃ | K₂O |
| FA (%) | 57.50 | 29.30 | 6.00 | 2.95 | 1.36 | 2.60 | NA | NA |
| CKD (%) | 11.0 | 3.90 | 42.0 | 2.0 | 3.6 | NA | NA | 0.6 |

### Methods

In a representative example, the hybrid GP-BP cementitious material was a mixture of two separate pumpable grout streams, one composed of class F fly ash, cement kiln dust, superplasticizer and water, and the other containing sodium hydroxide, sodium silicate, BP and water.

To prepare the first stream, FA and CKD were mixed for 5 min to obtain a homogenous mixture. Then water and superplasticizer were added. To prepare the second stream, NaOH pellets were dissolved in sodium silicate solution and left at room temperature to cool down. This solution was made at least one day prior to use. BP was added to the solution and well mixed before use.

After both streams were ready, they were mixed in a mixer thoroughly and the fresh binder was cast into cylindrical molds (25.4 mm in diameter and 50.8 mm in height). The molds were then placed in an oven for curing at 35° C. After 24 hours, the specimens were removed from the molds, sealed with plastic bags and put back in the oven to cure at 35° C. until the test day.

The two mentioned streams were prepared at a total water to solid (W/S) ratio of 0.5 and 0.55, respectively, for the cementitious material. CKD was added at a dosage of 0, 10, 15, and 20 wt. % of FA, respectively. The alkaline solution was prepared with a SS/SH ratio of 1 and a SH concentration of 5 M.

Systematic tests were performed to evaluate the setting time, rheology, and mechanical properties of the two streams and/or the cementitious material. Setting time tests were carried out on the cementitious material specimens following ASTM C191-08. Fresh cementitious material was cast in VICAT molds and put in an oven at 35° C. Molds were taken out of the oven at intervals of 10 min and setting time was measured using the VICAT apparatus and the results were reported as initial and final setting times. Viscosity tests were performed on the two streams using a coaxial cylinder viscometer (Fann model 35A) according to the instruction provided in API Spec 10 (1988). Unconfined compressive tests were conducted on the cementitious material specimens after 7 days' curing following ASTM C39/C39M using ELE Tri Flex 2 loading machine at a constant loading rate of 0.1 mm/min. The end surfaces of the specimens were polished to ascertain that they are flat and parallel.

### Results and Discussion

### Setting Time

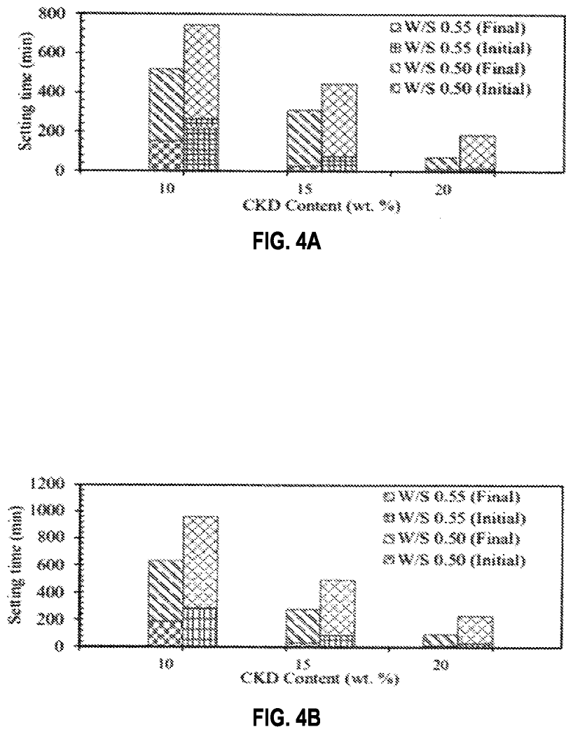

For field applications, after the two streams are poured into the crib bag, the mixture needs to gain strength quickly. Therefore, the setting time of the geopolymer binder is of great importance. In this regard, VICAT tests were conducted to investigate the effect of water content (W/S of 0.5 and 0.55), inclusion of CKD (0, 10, 15, and 15 wt. % of FA), and addition of superplasticizer (SP) (1 and 2 wt. % of FA+CKD) on the setting time of the GP cementitious material at 0 wt. % BP. The results are shown in FIGS. 4A and 4B, respectively. The results at 0 wt. % CKD are not shown in the figures because even the initial setting time was longer than 12 hours.

As can be seen, the addition of CKD as a calcium source decreased the setting time significantly. For example, the initial and final setting times at 10, 15, and 20 wt. % of CKD with W/S=0.50 and 1 wt. % SP were 153, 28, and 13 min and 366, 283, and 60 min, respectively.

The increase of W/S from 0.5 to 0.55 increased the setting time. For instance, the initial setting time increased from 13 min to 17 min and the final setting time from 60 min to 170 min for the GP cementitious material with 20 wt. % CKD and 1 wt. % SP, respectively. Moreover, the addition of SP increased the initial and final setting times. For example, increasing the SP content from 1 wt. % to 2 wt. % increased the initial setting time from 17 min to 26 min and the final setting time from 170 min to 202 min for the GP cementitious material with W/S=0.50 and 20 wt. % CKD, respectively. Overall, the results showed that CKD had a major effect on the setting time with different W/S and SP ratios. Finally, 20 wt. % CKD was selected in the studies of workability and mechanical properties. Regarding the BP included in the second stream, it essentially had no effect on the setting time of the GP cementitious material at the levels that were tested.

### Pumpability

For field applications, the first and second streams needed to be pumped in separate pipes for a long distance (e.g., more than 1500 meters) to the underground mine. Therefore, it was important to ensure that the two streams had good pumpability. The first stream was a mixture of FA, CKD, SP and water. The pumpability of the first stream was investigated through viscosity tests for a W/S of 0.50 and 0.55 at a SP dosage of 0 wt. %, 1 wt. % and 2 wt. %, respectively. The second stream was an alkaline solution containing a small percentage of BP, and thus can be easily pumped. Therefore, no viscosity test was done on the second stream.

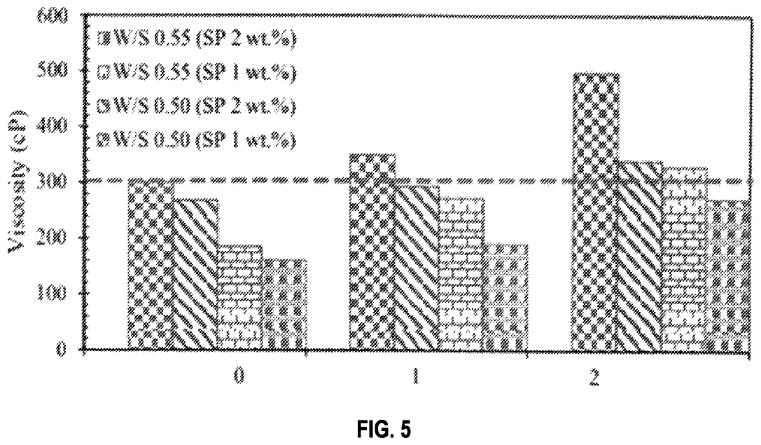

FIG. 5 shows the measured viscosity of the first stream at a time of 0, 1, and 2 hours after the materials were mixed, respectively. The results at 0 wt. % SP are not shown in the figure because the viscosity was much higher than 300 cP at all conditions. The viscosity tended to increase with time. For instance, the viscosity at W/S=0.50 and 1 wt. % SP increased from 300 cP right after mixing to 350 and 499 cP at 1 and 2 hours after mixing, respectively. The inclusion of SP and increase of the W/S ratio both decreased the viscosity of the first stream.

A stream with a viscosity below 300 cP is considered pumpable. As can be seen in FIG. 5, the first stream with W/S of 0.55 and 2 wt. % SP had a viscosity smaller than 300 cP even 2 hours after mixing. Again, the second stream was an alkaline solution containing SS, SH and BP, and had a viscosity below 300 cP.

### Mechanical Properties

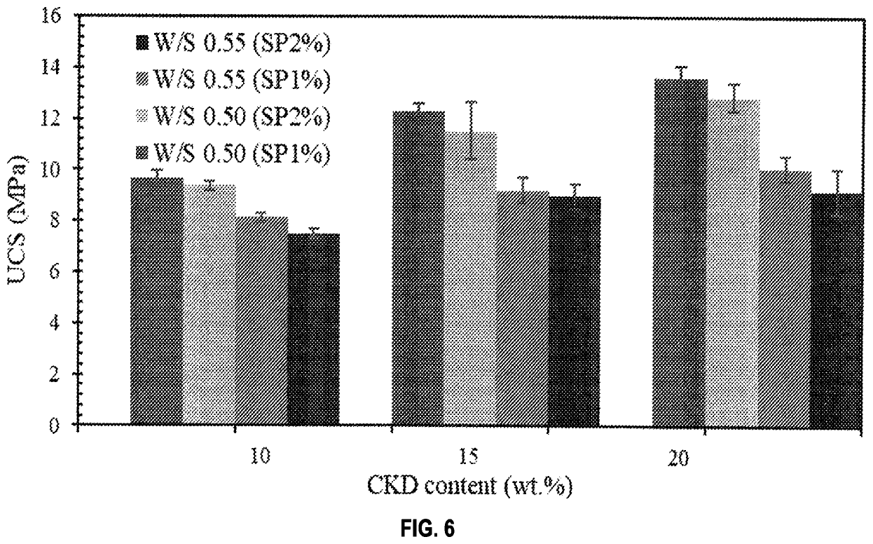

FIG. 6 shows the measured 7-day unconfined compressive strength (UCS) of the GP cementitious material at different CKD contents, W/S ratios and SP percentages. As can be seen, increasing the amount of CKD leads to an increase of the UCS of the GP cementitious material. For example, at W/S=0.50 and 1 wt. % SP, when 10, 15, and 20 wt. % of CKD was included, a UCS of 9.64, 12.3, and 13.6 MPa was obtained, respectively. This was possibly due to the formation of additional calcium-silicate-hydrate (CSH) gels along with the aluminosilicate geopolymer gels. As expected, increasing the W/S ratio or using SP leads to a decrease of the UCS. For instance, at 20 wt. % CKD and 1 wt. % SP, increasing the W/S ratio from 0.50 to 0.55 decreased the UCS from 13.6 MPa to 10.1 MPa; at 20 wt. % CKD and W/S=0.50, increasing SP from 1 wt. % to 2 wt. % reduced the UCS from 13.6 MPa to 12.9 MPa.

To enhance the mechanical performance of the GP cementitious material, BP (Gellan gum) was used. Gellan gum is a high molecular weight polysaccharide fermented from Sphingomonas elodea microbes. In this study, the BP was added at the following dosages: 0, 0.1, 0.2, 0.3, 0.4, and 0.5 wt. % (relative to the sum of the weights of FA and CKD) into the GP cementitious material with W/S=0.55, 20 wt. % CKD, and 2 wt. % SP. UCS tests were performed to determine the mechanical properties of the hybrid geopolymer-biopolymer cementitious materials.

FIG. 7 shows the stress-strain curves of the hybrid cementitious material specimens containing different percentages of BP (the BP was Gellan gum). As can be seen, by incorporating BP, the peak stress slightly decreased, but the residual strength increased. The highest residual strength occurred at 0.3 wt. % BP. Several other studies have also shown the improvement of ductility and toughness after addition of BP into geopolymer. It was also noted that 7-day UCS of the hybrid cementitious material specimen at 0.3 wt. % BP was 6.87 MPa which was much higher than the cementitious material currently used in practice for pumpable roof supports.

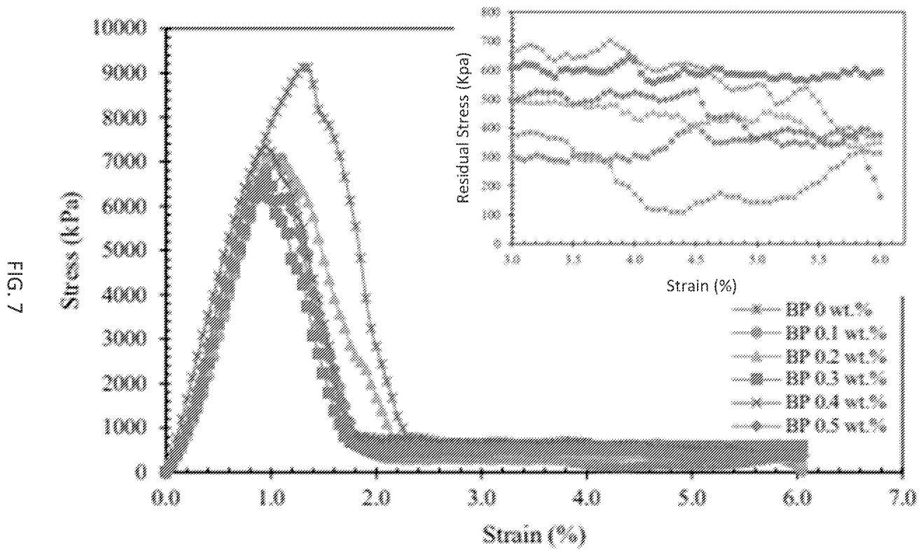

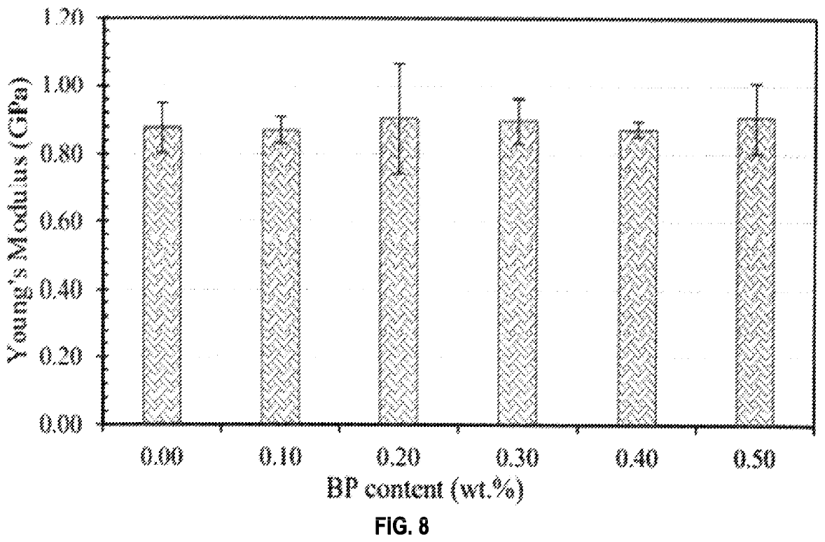

FIG. 8 shows the Young's modulus of the hybrid cementitious material specimens at different BP contents (i.e., 0 wt. %, 0.1 wt. %, 0.2 wt. %, 0.3 wt. %, and 0.5 wt. %. relative to the sum of the weights of FA and CKD) and with W/S=0.55, 20 wt. % CKD, and 2 wt. % SP. The Young's modulus was calculated following ASTM E111-17 by using the slope of the stress-strain curve between the preload point and the yield stress point. As can be seen, inclusion of BP resulted in no to slight change of the Young's modulus.

Based on the obtained results, several observations were made. First, the setting time of the hybrid cementitious material decreased with addition of CKD as a calcium source. A 20 wt. % of CKD could be considered for ensuring quick curing of the hybrid cementitious material. Additionally, it was observed that the pumpability of the first stream at 20 wt. % CKD was impacted by SP and W/S ratio. Using 2 wt. % SP and W/S=0.55 was sufficient to ensure a viscosity less than 300 cP for the first stream, even 2 hours after mixing. The second stream was an alkaline solution containing a very small amount of BP and thus was easily pumped. Finally, it was observed that inclusion of CKD increased the UCS of geopolymer specimens. Incorporation of biopolymer slightly decreased the UCS but increased the residual strength and did not change (or slightly increased/decreased) the Young's modulus of the geopolymer specimens. Considering the much higher UCS of the geopolymer cementitious material than the currently used cementitious materials in practice, the hybrid geopolymer-biopolymer cementitious material can be considered as a promising new cementitious material for pumpable roof supports.

### Application 2

### Preliminary Small-Scale Demonstration and Validation

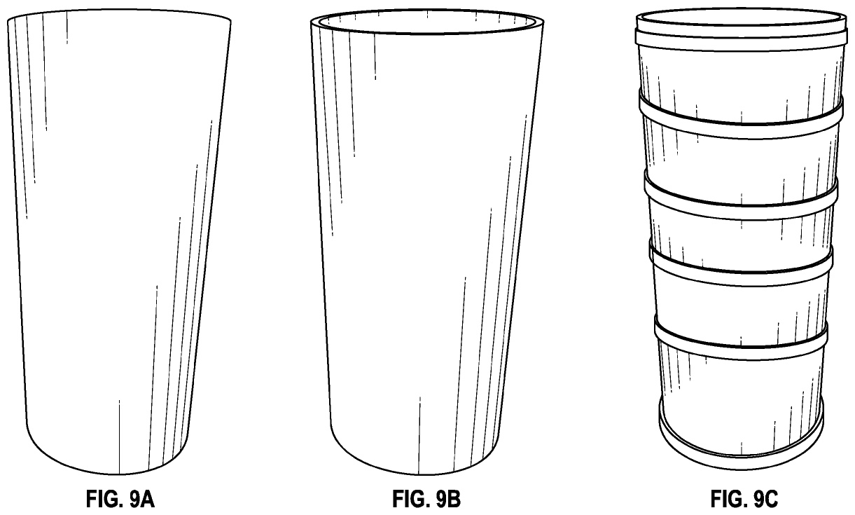

As a preliminary demonstration and validation, small size (152.4 mm diameter and 304.8 mm height) cylinder specimens with no bag, with bag, and with bag and plastic cable ties outside the bag were produced and tested (FIGS. 9A-9C). Small size hybrid cementitious material cylinder specimens with 5 M NaOH, SS/SH=1, 20 wt. % CKD, 2 wt. % SP, 0.3 wt. % CAR, and cured at 35° C.: FIG. 9A with no bag; FIG. 9B with bag; and FIG. 9C with bag and plastic cable ties. The bags were manufactured using polyester fabric and the plastic cable ties were used to partially represent the reinforcement wires of crib bags used in practice. Considering the scope of work, only the hybrid cementitious material with 20 wt. % CKD, W/S=0.60, 2 wt. % SP, and in this case 0 or 0.3 wt. % carrageenan (CAR) as BP was prepared for producing the cylinder specimens. Unconfined compression tests were conducted on the cylinder specimens following ASTM C39/C39M (2016) with the Test Mark CM-3000 machine at a loading rate of 0.25 MPa/sec.

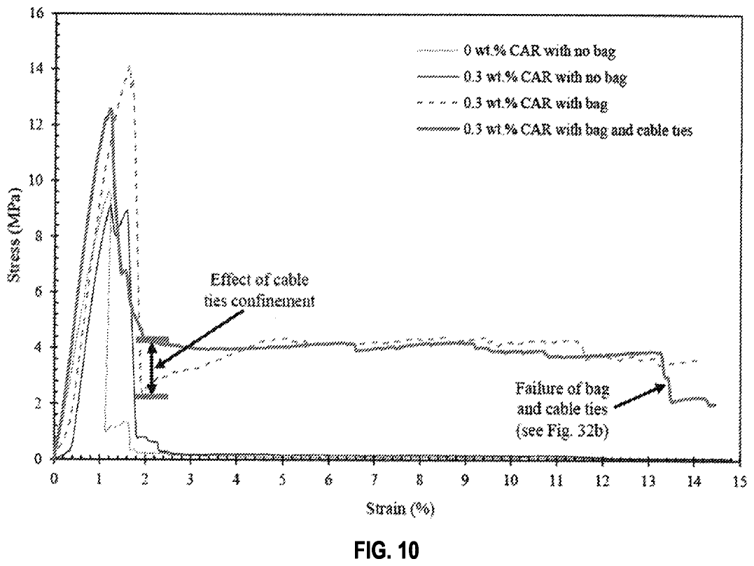

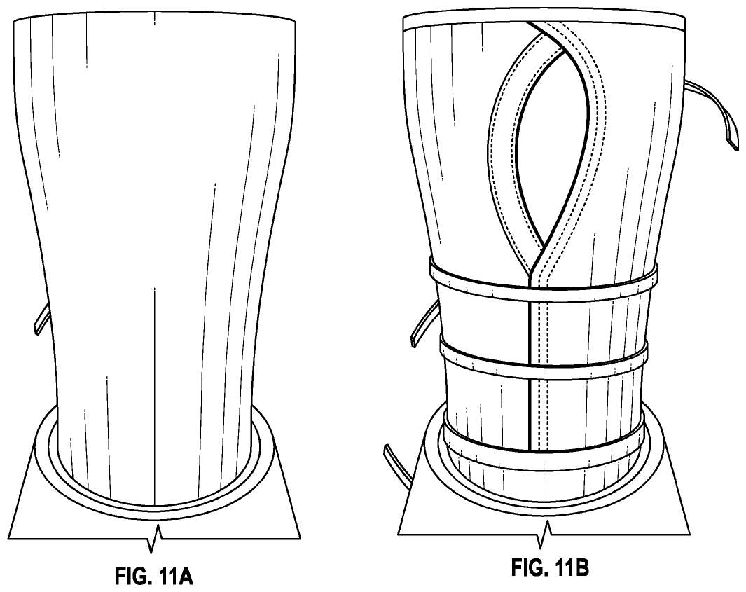

FIG. 10 shows the axial stress-strain curves of the 0 wt. % CAR specimen with no bag, the 0.3 wt. % CAR specimen with no bag, the 0.3 wt. % CAR specimen with bag, and the 0.3 wt. % CAR specimen with bag and plastic cable ties. For the two specimens with no bag, the incorporation of biopolymer resulted in a slight decrease in the peak UCS but an increase in the residual UCS. With inclusion of 0.3 wt. % CAR, the peak UCS slightly deceased from 9.66 MPa to 9.11 MPa but the residual UCS at 13% strain increased from 0.09 MPa to 0.19 MPa. With the utilization of bag and plastic cable ties, both the peak UCS and residual UCS increased significantly. Specifically, the peak UCS increased from 9.66 MPa to 14.1 MPa (with only bag) and 12.5 MPa (with bag and plastic cable ties) and the residual UCS at 13% strain increased from 0.19 MPa to 3.87 MPa (with only bag) and 4.0 MPa (with bag and plastic cable ties), respectively. The effect of the external reinforcement from the plastic cable ties on the peak and residual strength was not significant possibly because the plastic cable ties were not so stiff as the metal wires used in real crib bags and failed during the test (compare FIGS. 11A and 11B; small size bagged hybrid cementitious material cylinder specimens with 5 M NaOH, SS/SH=1, 20 wt. % CKD, 2 wt. % SP, 0.3 wt. % CAR, and cured at 35° C. after failure: FIG. 11A with polyester bag; and FIG. 11B with polyester bag and plastic cable ties.). However, the plastic cable ties decreased the sudden drop of stress right after the peak as shown FIG. 10. It was also noted that the bag failed along the sewing line, indicating that the string used for sewing the fabric was not strong enough.

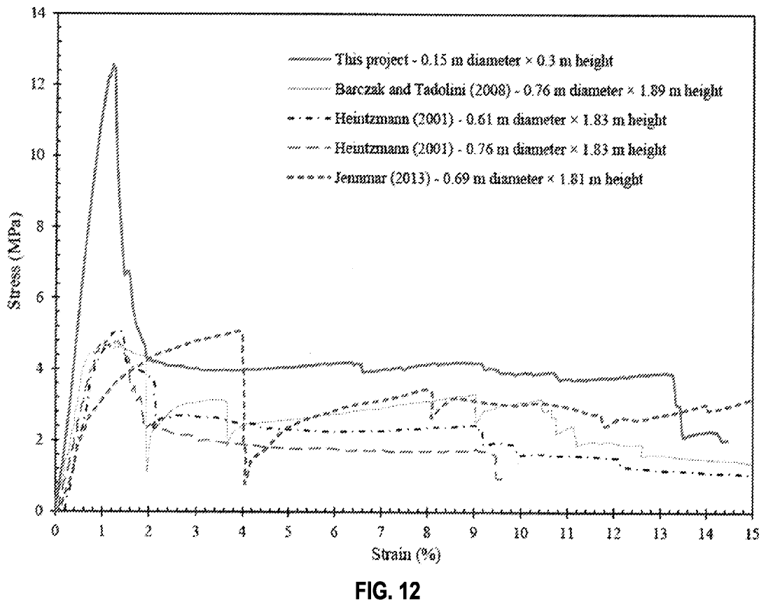

As a comparison, FIG. 12 shows the stress-strain curve of the small size 0.3 wt. % CAR specimen with bag and plastic cable ties and those of full-size crib bag specimens currently used in practice. As can be clearly seen, the 0.3 wt. % CAR specimen with bag and plastic cable ties and containing the hybrid GP-BP cementitious material had significantly higher peak strength than the full-size crib bag specimens currently used in practice. The residual strength of the former was also much higher than the latter. It needs to be noted that the plastic cable ties are much more flexible than the metal wire reinforcement used in the full size crib bags.

### Residual UCS

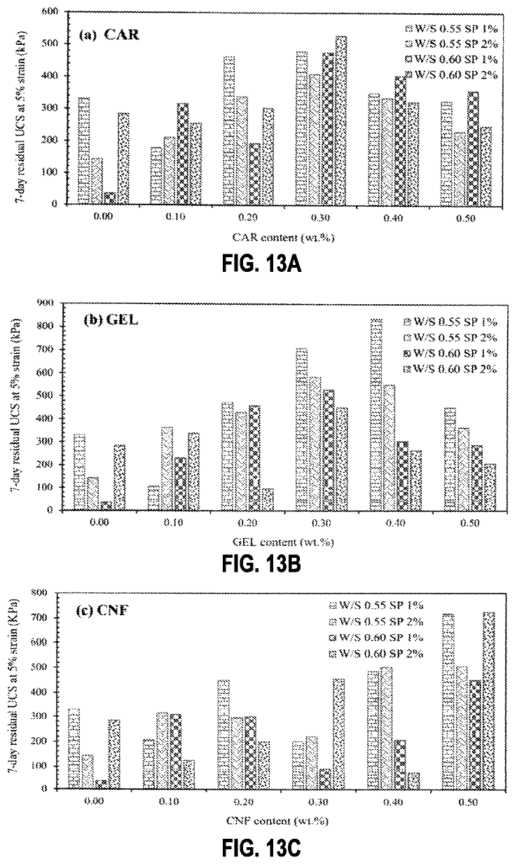

FIGS. 13A-13C show the effect of BP content on 7-day residual UCS of hybrid cementitious material at 5% strain with 20 wt. % CKD, W/S=0.55 and 0.60, 1 and 2 wt. % SP, and cured at 35° C.: FIG. 13A Carrageenan (CAR); FIG. 13B Gellan gum (GEL); and FIG. 13C Cellulose nanofibers (CNF). Because the residual strength changes with strain randomly, only the residual UCS at 5% strain is shown in the figure for easy discussion. It can be seen that the inclusion of BP may lead to increase or decrease of the residual UCS, depending on the W/S ratio, SP amount and BP content. However, the results clearly show that at 0.3 wt. % carrageenan (CAR), 0.3 wt. % gellan gum (GEL), and 0.5 wt. % cellulose nanofibers (CNF), the 7-day residual UCS reaches the highest or second highest value at nearly all W/S ratios and SP amounts and the values are much higher than the corresponding values at 0 wt. % BP. So, by including an appropriate amount of BP, the residual UCS of the hybrid cementitious material can be significantly increased. This is in agreement with previous studies which showed the improvement of ductility and toughness of geopolymer after inclusion of BP. It can also be seen from FIGS. 13A-13C that the increase of W/S ratio or SP dosage may lead to increase, decrease or essentially no change of the 7-day residual UCS, depending on the W/S ratio, the SP amount, and the BP type and content. This is possibly due to the different interactions at various W/S ratios, SP amounts and BP types and contents. It may also be because the residual UCS varies randomly with strain, and FIGS. 13A-13C only show the residual UCS values at 5% strain. Based on the results in FIGS. 13A-13C about the 7-day residual UCS at different BP types and contents, 0.3 wt. % carrageenan (CAR), 0.3 wt. % gellan gum (GEL), and 0.5 wt. % cellulose nanofibers (CNF) were selected as the respective BP dosage for the hybrid cementitious material so that the highest residual strength can be obtained.

### LISTING OF FURTHER EXAMPLES

A non-limiting list of additional examples of the present inventive concept is provided below.

### Example 1

A hybrid cementitious material composition for pumpable roof support in underground mines, said composition comprising a mixture comprising a first grout stream and a second grout stream, wherein both the first and second gout streams are pumpable. The first grout stream comprises a precursor and water. The precursor can comprise both a pozzolanic material such as fly ash, and ordinary Portland cement (i.e. cement kiln dust). The first grout stream can optionally further comprise a superplasticizer. The second grout stream comprises sodium silicate and/or potassium silicate, sodium hydroxide and/or potassium hydroxide and/or calcium hydroxide, a biopolymer, and water. The fly ash in the first gout stream can comprise a source of aluminosilicate and the cement kiln dust can comprise ordinary Portland cement and/or lime.

### Example 2

The cementitious material composition of example 1, wherein the fly ash in said first grout stream comprises metakaolin and/or slag.

### Example 3

The cementitious material composition of any one of examples 1 to 2, wherein the first grout stream comprises the superplasticizer in an amount in a range from about 1 wt. % to about 4 wt. %, or even about 2 wt. %, relative to a sum of the weight of the fly ash and the cement kiln dust.

### Example 4

The cementitious material composition of any one of examples 1 to 3, wherein a ratio of water to solids for the mixture comprising the first grout stream and the second grout stream is in a range from about 0.5 to about 0.7, from about 0.5 to about 0.65, or even about 0.6.

### Example 5

The cementitious material composition of any one of examples 1 to 4, wherein the cement kiln dust in the first grout stream is present in a range from about 10 wt. % to about 30 wt. %, or even about 20 wt. %, relative to the weight of the fly ash.

### Example 6

The cementitious material composition of any one of examples 1 to 5, wherein said sodium hydroxide is present in in an amount in a range from about 3 to about 15 mol, or even about 5 mol.

### Example 7

The cementitious material composition of any one of examples 1 to 6, wherein said sodium silicate to sodium hydroxide ratio is present in a range from about 0 to about 3, or even about 1.

### Example 8

The cementitious material composition of any one of examples 1 to 7, wherein the mixture comprising the first grout stream and the second grout stream exhibits an initial setting time in a range from about 20 minutes to about 40 minutes and a final setting time in a range from about 60 minutes to about 360 minutes.

### Example 9

The cementitious material composition of any one of examples 1 to 9, wherein the biopolymer in the second grout stream is chosen from carrageenan, gellan gum, cellulose nanofibers, xanthan gum, agar, or cellulose nanofibers.

### Example 10

The cementitious material composition of any one of examples 1 to 10, wherein the biopolymer in the second grout stream is chosen from carrageenan, gellan gum, and cellulose nanofibers.

### Example 11

The cementitious material composition of any one of examples 1 to 11, wherein said biopolymer is present in an amount in a range from about 0 wt. % to about 1 wt. %, from about 0.1 wt. % to about 1 wt. %, from about 0.2 wt. % to about 0.5 wt. %, from about 0.3 wt. % to about 0.5 wt. %, about 0.3 wt. %, or even about 0.5 wt. %, relative to a total weight of the precursor (i.e. the fly ash and the cement kiln dust).

### Example 12

The cementitious material composition of any one of examples 1 to 12, wherein a sodium silicate to sodium hydroxide ratio is present in a range from greater than 0 to about 3.

### Example 13

The cementitious material composition of any one of examples 1 to 12, wherein the viscosities of the first grout stream and the second grout stream are each no greater than about 300 cP.

### Example 14

The cementitious material composition of any one of examples 1 to 13, wherein the viscosities of the first grout stream and the second grout stream are each no greater than about 300 cP for at least 1 hour after preparation.

### Example 15

The cementitious material composition of any one of examples 1 to 14, wherein the viscosities of the first grout stream and the second grout stream are each no greater than about 300 cP for at least 2 hours after preparation.

### Example 16

The cementitious material composition of any one of examples 1 to 15, wherein a cured form of the cementitious material has a peak unconfined compressive strength of greater than about 12.0 MPa.

### Example 17

The cementitious material composition of any one of examples 1 to 16, wherein a cured form of the cementitious material has a Young's modulus in a range from about 0.70 GPa to about 1.30 GPa.

### Example 18

The cementitious material composition of any one of examples 1 to 17, wherein a cured form of the cementitious material has a residual unconfined compressive strength of greater than 3.0 MPa.

### Example 19

A method of preparing a cementitious material composition, said method comprising separately pumping a first grout stream according to any one of examples 1 to 18 and a second grout stream according to any one of examples 1 to 18 to a mixing location (e.g., a crib bag or other separate location), and forming, at the mixing location, a mixture of the first grout stream and the second grout stream to form the cementitious material composition. In some aspects, the mixing location can be a location in an underground mine.

### Example 20

The method according to example 19 can further include allowing time for the cementitious material composition to cure.

### Example 21

The method according to any one of examples 19 to 20 can further include preparing the first grout stream by (a) mixing a pozzolanic material such as fly ash with cement kiln dust to obtain a homogeneous mixture and (b) adding water and a superplasticizer and mixing further to obtain the first grout stream. The method according to any one of examples 19 to 20 can also further include preparing the second grout stream by (a) forming an aqueous solution of sodium hydroxide and/or potassium hydroxide and/or calcium hydroxide, and sodium silicate and/or potassium silicate, and (b) adding a biopolymer to the aqueous solution to obtain the second grout stream.

### Example 22

The method according to any one of examples 19 to 21, wherein the first grout stream and the second grout stream are separately pumped from locations independently selected to be above ground level, at ground level, or below ground level.

### Example 23

The method of any one of examples 19 to 22, wherein the mixing location comprises a crib bag attached to a surface of the underground mine, and wherein the crib bag contains the cementitious material composition.

### Example 24

The method of any one of examples 19 to 23, wherein the surface of the underground mine is a roof in the underground mine.

### Example 25

A method of making a cured cementitious support in an underground mine, the method comprising separately pumping a first grout stream and a second grout stream according to any one of examples 1 to 18 a location within an underground mine, forming, at the location within the underground mine, a combination of the first grout stream and the second grout stream, mixing the combination from step (b) and pumping the resulting cementitious material composition into a container and allowing the cementitious material composition to cure within the container to provide a cured cementitious support in the underground mine. In some aspects, the container is optionally a crib bag attached to a surface of the underground mine.

### Example 26

A cementitious material composition for pumpable roof supports in underground mining, the cementitious material composition comprising a mixture comprising a first grout stream and a second grout stream. The first grout stream can comprise one or more precursor source materials (e.g. fly ash) and water, and the second grout stream can comprise a biopolymer, a sodium silicate or potassium silicate, water, and a hydroxide chosen from potassium hydroxide, calcium hydroxide, and sodium hydroxide. In some aspects, the first and second grout streams are both pumpable, and the precursor of the first grout stream can further comprise cement kiln dust (CKD), ordinary Portland cement (OPC), and/or lime. The first grout stream can also further comprise a superplasticizer.

### Example 27

A hybrid cementitious material composition for pumpable roof supports in underground mining comprising a mixture of a first grout stream and a second grout stream. The first grout stream comprises class F fly ash (FA), cement kiln dust (CKD), superplasticizer (SP) and water; and the second grout stream comprises sodium silicate, sodium hydroxide, biopolymer (BP) and water. Both the first grout stream and the second grout stream can be configured to be pumpable. The first grout stream can optionally use metakaolin, slag or other aluminosilicate source materials for FA and ordinary Portland cement (OPC) or lime for CKD; and the second grout stream can optionally use potassium silicate for sodium silicate and potassium hydroxide or calcium hydroxide for sodium hydroxide.

### Example 28

The cementitious material composition of example 27, wherein the biopolymer in the second grout stream is chosen from carrageenan (CAR), gellan gum (GEL), and cellulose nanofibers (CNF).

### Example 29

The cementitious material composition of example 27, wherein the first grout stream further comprises a superplasticizer in an amount in a range from about 1 wt. % to about 4 wt. % relative to a total weight of FA and CKD (preferably about 2 wt. %).

### Example 30

The cementitious material composition of claim 1, wherein a ratio of water to solids for the mixture comprising the first grout stream and the second grout stream is in a range from about 0.5 to about 0.7 (preferably, from about 0.5 to about 0.65, more preferably about 0.6).

### Example 31

The cementitious material composition of claim 1, wherein the cement kiln dust in the first grout stream is present in a range from about 10 wt. % to about 30 wt. % of the fly ash (preferably, 20 wt. %).

### Example 32

The cementitious material composition of example 27, wherein the mixture comprising the first grout stream and the second grout stream exhibits an initial setting time in a range from about 20 min to about 40 min and final setting time in a range from about 60 minutes to about 360 minutes.

### Example 33

The cementitious material composition of example 27, wherein the viscosities of the first grout stream and the second grout stream are each no greater than about 300 cP.

### Example 34

A method of preparing a cementitious material comprising separately pumping the first grout stream according to example 1 and the second grout stream according to example 1 from a first location to a second location, forming, at the second location, a combination of the first grout stream and the second grout stream, and mixing, at the second location, the combination from step (b) to form the cementitious composition.

### Example 35

The method according to example 34, can further comprise allowing time for the cementitious material to cure.

### Example 36

The method according to example 34, wherein the first grout stream is prepared by first mixing fly ash and cement kiln dust to obtain a homogeneous mixture, and then adding water and superplasticizer and mixing further to obtain the first grout stream. The second grout stream can be prepared by dissolving NaOH pellets in a sodium silicate/water solution at least one day prior to use, and allowing the solution to cool to ambient temperature; and adding a biopolymer to the sodium silicate-sodium hydroxide-water solution and mixing well to obtain the second grout stream.

### Example 37

The method according to example 34, wherein the first location is above ground level and the second location is within a mine located below ground level.

### Example 38

A method of producing a pumpable cementitious support in an underground mine, the method comprising separately pumping the first grout stream and the second grout stream according to example 1 from a first location to a second location, wherein the first location is above ground level and the second location is within a mine located below ground level, forming, at the second location, a combination of the first grout stream and the second grout stream, mixing, at the second location, the combination of the first and second grout streams and pumping the mixture into the crib bag, and allowing the cementitious material to cure within the crib bag to provide a cured pumpable cementitious support on the surface of the mine.

### Example 39

The method of example 38, wherein the surface of the mine is a roof in the underground mine.

### Example 40

The cementitious material composition of example 27, wherein said biopolymer is present in an amount in a range from about 0 wt. % to about 0.5 wt. % relative to a total weight of FA+CKD.

### Example 41

The cementitious material composition of example 28, wherein said carrageenan (CAR) is present in an amount in of about 0.3 wt. %.

### Example 42

The cementitious material composition of example 28, wherein said gellan gum (GEL) is present in an amount in of about 0.3 wt. %

### Example 43

The cementitious material composition of example 28, wherein said cellulose nanofibers (CNF) is present in an amount in of about 0.5 wt. %

### Example 44

The cementitious material composition of example 27, wherein said sodium hydroxide is present in in an amount in a range from about 3 to about 15 mol (preferably about 5 mol).

### Example 45

The cementitious material composition of example 27, wherein said sodium silicate to sodium hydroxide ratio is present in a range from about 0 to about 3 (preferably about 1).

### Example 46

The cementitious material composition of example 27, wherein the viscosities of the first grout stream and the second grout stream are each no greater than about 300 cP at least 2 hours after mixing.

### Example 47

The cementitious material composition of example 27, wherein the viscosities of the first grout stream and the second grout stream are each no greater than about 300 cP at least 1 hour after mixing.

### Example 48

The cementitious material composition of example 27, wherein the cementitious material with a crib bag has a peak unconfined compressive strength (UCS) greater than 12.0 (MPa).

### Example 49

The cementitious material composition of example 27, wherein the Young's modulus of the cementitious material with a crib bag is in the range of 0.70 to 1.30 GPa.

### Example 50

The cementitious material composition of example 27, wherein the cementitious material with a crib bag has a residual unconfined compressive strength (UCS) greater than 3.0 (MPa).

### Example 51

A cementitious composition for pumpable roof supports in underground mining, the cementitious composition comprising a mixture comprising a first grout stream and a second grout stream. The first grout stream can comprise one or more precursor specimens (e.g. a pozzolanic material, ordinary Portland cement) and water. The precursor can optionally comprise fly ash, cement kiln dust (CKD), ordinary Portland cement (OPC), limestone or a combination thereof. The second grout steam can comprise sodium silicate and/or potassium silicate, water, a biopolymer, and a hydroxide chosen from potassium hydroxide calcium hydroxide, and sodium hydroxide or a combination thereof. In some aspects, both the first grout stream and the second grout stream are pumpable.

It should be understood from the foregoing that, while particular embodiments have been illustrated and described, various modifications can be made thereto without departing from the spirit and scope of the inventive concept as will be apparent to those skilled in the art. Such changes and modifications are within the scope and teachings of this inventive concept as defined in the claims appended hereto.

What is claimed is:

1. A hybrid cementitious material composition, the composition comprising:
a first mixture, including:
a precursor, including:
pozzolanic material(s),
ordinary Portland cement, and
water; and
a second mixture combined with the first mixture, including:
a silicate,
a hydroxide,
a biopolymer, and
water.

2. The hybrid cementitious material composition of claim 1, wherein the first mixture and second mixture are both pumpable.

3. The hybrid cementitious material composition of claim 1, wherein the first mixture and second mixture are mixed to form the hybrid cementitious material composition.

4. The hybrid cementitious material composition of claim 1, wherein the first mixture further comprises a superplasticizer.

5. The hybrid cementitious material composition of claim 4, wherein the superplasticizer is present in an amount ranging from about 1 wt. % to about 4 wt. % relative to weight of the precursor.

6. The hybrid cementitious material composition of claim 1, wherein the precursor is selected from fly ash, cement kiln dust, ordinary Portland cement, lime, or a combination thereof.

7. The hybrid cementitious material composition of claim 6, wherein the cement kiln dust is present in an amount ranging from about 10 wt. % to about 30 wt. % relative to a weight of the fly ash.

8. The hybrid cementitious material composition of claim 1, wherein a ratio of water to solids for the hybrid cementitious material composition ranges from about 0.5 to about 0.7.

9. The hybrid cementitious material composition of claim 1, wherein the biopolymer is selected from carrageenan, gellan gum, xanthan gum, guar gum, agar, cellulose nanocrystals, cellulose nanofibers, or a combination thereof.

10. The hybrid cementitious material composition of claim 1, wherein the biopolymer is present in an amount ranging from about 0.1 wt. % to about 0.5 wt. % relative to a weight of the precursor.

11. The hybrid cementitious material composition of claim 1, wherein the biopolymer is present in an amount of 0.3 wt. % relative to a weight of the precursor.

12. The hybrid cementitious material composition of claim 1, wherein the silicate is selected from sodium silicate, potassium silicate, or a combination thereof.

13. The hybrid cementitious material composition of claim 1, wherein the hydroxide is selected from sodium hydroxide, potassium hydroxide, calcium hydroxide, or a combination thereof, and is present in an amount ranging from about 3 mol to about 15 mol.

14. The hybrid cementitious material composition of claim 1, wherein a ratio of silicate to hydroxide present in the second mixture ranges from about 1 to about 3.

15. The hybrid cementitious material composition of claim 1, wherein the first mixture and the second mixture each have a viscosity no greater than 300 cP.
